(19) United States
(12) Patent Application Publication
(10) Pub. No.: US 2004/0018289 A1
(43) Pub. Date: Jan. 29, 2004

(54) Method of facilitating recollection of a wine consumed from a bottle

(76) Inventors: Thomas P. McQueeny, Chicago, IL (US); James M. Irish, San Diego, CA (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/392,045

(22) Filed: Mar. 19, 2003

Related U.S. Application Data
(60) Provisional application No. 60/365,756, filed on Mar. 19, 2002.

(51) Int. Cl. A23L 1/00

(52) U.S. Cl. 426/538; 99/275

(57) ABSTRACT

In order to foster the recall of a particular bottle of wine, an important event, a specific location or the like, a method of facilitating recollection of a wine which has been consumed from a bottle is provided. The method includes the steps of providing a base label for the bottle, and printing indicia on the base label including at least legally required product information. The method also includes the steps of providing a top label for the bottle, and then printing indicia on the top label including at least wine recollection facilitating information. The method further includes the step of releaseably securing the top label to the base label to form a composite label in a manner permitting the top label to be separated from the base label. The method additionally includes the step of permanently securing the base label to the bottle in the sense that the base label remains on the bottle upon separation of the top label from the base label. With this method, a consumer who has enjoyed a wine, an event, a location, or the like may have recollection thereof by removing the top label from the base label and retaining the top label for this purpose.

This nonprovisional patent application of McQueeny, et al. Claims the benefit of a prior-filed provisional patent application which was assigned provisional application No. 60/365,756 and a filing date of Mar. 19, 2002.

### FIELD OF THE INVENTION

The present invention is generally directed to enhancing the marketing of bottled wines and, more particularly, to a method of facilitating recollection of a wine consumed from a bottle.

### BACKGROUND OF THE INVENTION

In recent years, there has been a continuously growing appreciation for wines that come from all corners of the world. This growing appreciation for wines is also reflected in increased wine consumption together with the formation and growth of many new vineyards in the various wine producing regions of the world. However, as a by-product of the number of vineyards, there is a corresponding problem that faces the ordinary consumer of wine.

In particular, the ordinary consumer may experience a wine and want to purchase a quantity of the wine at a later date. This may happen, by way of example, when the consumer has ordered a bottle of wine with dinner at a restaurant or, perhaps, when a bottle of wine has been consumed at a special event such as a wedding or is enjoyed in the company of friends. However, even when the consumer purchases a bottle of wine for home consumption, it is difficult to recall the wine for a subsequent purchase at a later date.

In this connection, there are so many varieties of wine and vineyards that produce them, that it is exceedingly difficult to recall a favorite wine. The sheer number of wine regions, wine varieties, and vineyards in a well stocked wine department leads to much confusion on the part of the consumer. Also, due to the many different wine labels, it is difficult to select a wine that was consumed in the past by mere recollection of the label.

Of course, if the consumer of a wine could recall it with certainty, the vineyard that produced the wine would be the beneficiary. It would then be possible for the consumer to purchase a wine that had been enjoyed in the past with complete certainty and without the obstacles to recollection that are currently faced. If this could be done, good vineyards would prosper while consumers would eliminate the frustrations inherent in the purchase of wines.

While this would benefit both the vineyard and the consumer, there are still other reasons for wanting to recall a wine that has been consumed from a bottle. These reasons have lead consumers to attempt to find ways to remove wine labels, which is not easily accomplished. The authors of the book “Love by the Glass: Tasting Notes from a Marriage”, who have removed many labels from wine bottles, have frequently been asked for advice.

In response, they indicate that the first step is to remember to save the bottle, whether from a restaurant or at home, and to save the bottle in a prominent place until there are several to process at once. Then, they recommend filling a sink with hot water, laying a piece of plastic wrap across a counter, taking the empty bottles with corks removed and immersing them in the sink. After a period of time, they suggest attempting to peel the labels from the bottles after removing them from the sink, and laying the labels that can be peeled from the bottles flat on the plastic wrap.

For a label that won't peel away from its bottle, they recommend placing that bottle very carefully into boiling water. Next, they suggest using a knife to assist in attempting to remove labels that still will not peel from the bottle. Finally, for labels that begin to fall apart, they recommend placing the bottle where it can cool and then repeating the process.

As an alternative, the authors of the book “Love by the Glass: Tasting Notes from a Marriage” suggest a commercial solution, i.e. label removers which are essentially big strips of clear adhesive tape.

As will be apparent, the processes that are suggested by these authors are difficult or expensive and rather involved at best and even border on dangerous. They also are ill suited for consumers who simply wish to remember a wine that might be consumed on vacation or in another setting where transporting the bottle to one's home is cumbersome or even unacceptable. In such instances, the consumer has no alternative but to write down detailed information about the wine for later reference such as the vineyard, vintage, variety, etc.

However, where the consumer wishes to retain the label as a memento, writing down the name of the wine is entirely unsatisfactory. This suggests the very real fact that many consumers would like to be able retain the labels for a variety of reasons, e.g., the beauty of the artwork in the labels, the information contained on the labels, the event at which the wine was consumed, the location where the wine was consumed, and to facilitate recollection of the wine for later purchase of the same wine. Generally speaking, those who are regular consumers of wine understand that wine is often an important part of some great memories.

In view of all of the forgoing, there has remained a significant need for a method of facilitating recollection of a wine consumed from a bottle.

### SUMMARY OF THE INVENTION

The present invention is generally directed to a method of facilitating recollection of a wine which is consumed from a bottle. The method includes the steps of providing a base label for the bottle, and printing indicia on the base label including at least legally required product information. The method also includes the steps of providing a top label for the bottle, and printing indicia on the top label including at least wine recollection facilitating information. In addition, the method includes the steps of releaseably securing the top label to the base label and permanently securing the base label to the bottle.

More specifically, the top label is releaseably secured to the base label to form a composite label in a manner permitting the top label to be separated from the base label. Additionally, the base label is permanently secured to the bottle in the sense that the base label will remain on the bottle upon separation of the top label from the base label.

In a preferred embodiment, the base label includes an outer surface for printing indicia thereon and an inner surface directly opposite the outer surface adapted to be permanently secured to the bottle. The step of permanently securing the base label to the bottle advantageously includes the step of directly applying an adhesive to the inner surface of the base label after the composite label has been formed. Still additionally, the step of permanently securing the base label to the bottle advantageously includes the step of affixing the composite label to the bottle after applying the adhesive.

Preferably, the top label includes an outer surface for printing indicia thereon and an inner surface directly opposite the outer surface which is adapted to be releasably secured to the base label that is to be permanently secured to the bottle. The step of releaseably securing the top label to the base label advantageously includes the steps of (i) applying a release adhesive to the inner surface of the top label, (ii) applying a two layer high pressure laminate film having a release adhesive on the outer surface of one of the layers to the top label such that the film layer without release adhesive contacts the release adhesive on the inner surface of the top label, and (iii) thereafter affixing the top label with the two layer laminate film to the outer surface of the base label such that the release adhesive on the film contacts the outer surface of the base label. Still additionally, the method includes the step of printing indicia on the inner surface of the top label preferably includes printing such indicia at a point in time prior to applying the release adhesive used to adhere the two layer laminate film thereto.

In another preferred embodiment, the step of printing indicia on the outer surfaces of the top and base labels includes printing conventional wine label indicia. It is also advantageous for the step of printing indicia on the inner surface of the top label to include printing vineyard, vintage and variety information and/or information concerning the wine's characteristics. Still further, the step of printing indicia on the inner surface of the top label advantageously includes printing an area for consumers to make wine tasting or other notes.

Other objects, advantages and features of the present invention will become apparent from a consideration of the following description taken in conjunction with the accompanying drawings.

### BRIEF DESCRIPTION OF THE DRAWINGS

FIG. 1 is a front perspective view of a wine bottle having a composite label for practicing the method of the present invention.

FIG. 2 is a front perspective view of the wine bottle of FIG. 1 with a top label portion of the composite label partially removed;

FIG. 3 is a partially exploded cross-sectional view taken generally along the line 3-3 of FIG. 1 illustrating the composite label;

FIG. 4a is a front elevational view of a top label portion of a composite label illustrating indicia printed thereon;

FIG. 4b is a rear elevational view of a top label portion of a composite label illustrating indicia printed thereon;

FIG. 4c is a front elevational view of a base label portion of a composite label illustrating indicia printed thereon;

FIG. 4d is a front elevational view of a base label portion of a composite label illustrating a cut away corner;

FIG. 4e is a front elevational view of a top label portion of a composite label illustrating a peel away area;

FIG. 5 is a front perspective view of a wine bottle having an alternative composite label for practicing the method of the present invention;

FIG. 6 is a front perspective view after a top label has been removed from the alternative composite label of FIG. 5;

FIG. 7 is a front perspective view of a wine bottle having another alternative composite label for practicing the method of the present invention;

FIG. 8 is a side perspective view of the wine bottle of FIG. 7 with a top label portion of the composite label partially removed;

FIG. 9 is a front perspective view of a wine bottle having another alternative composite label for practicing the method of the present invention; and

FIG. 10 is a front perspective view of the wine bottle of FIG. 9 with a top label portion of the composite label removed.

### DETAILED DESCRIPTION OF THE PREFERRED EMBODIMENT

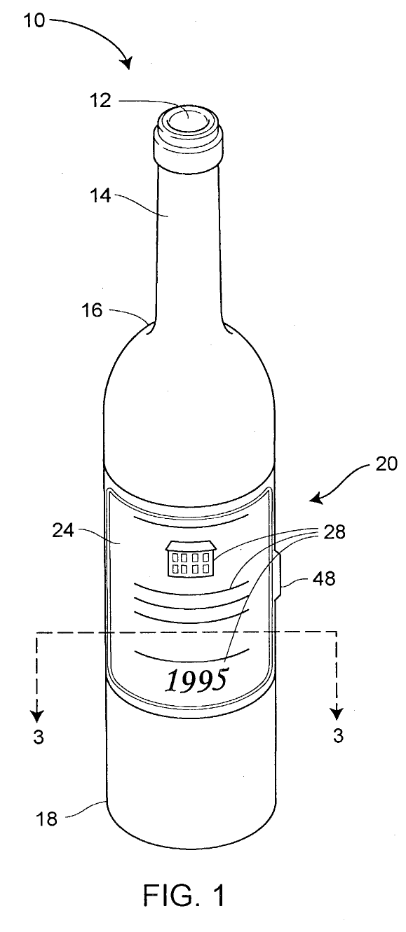

In the illustrations given, and with reference first to FIGS. 1-3, the reference numeral 10 designates generally a wine bottle that is shown merely as a representative example. The wine bottle 10 typically will include an opening 12 through which the wine may be poured following removal of a cork (not shown). The opening 12 is located at the end of a neck 14 which extends from a shoulder area 16 that forms a transition region between the neck 14 and the body 18 of the bottle that stores a major portion of the wine which is contained therein. In the illustrated embodiment, the wine bottle 10 will be seen to have a generally cylindrical body 18 although the shape of the bottle is of no concern in connection with the invention.

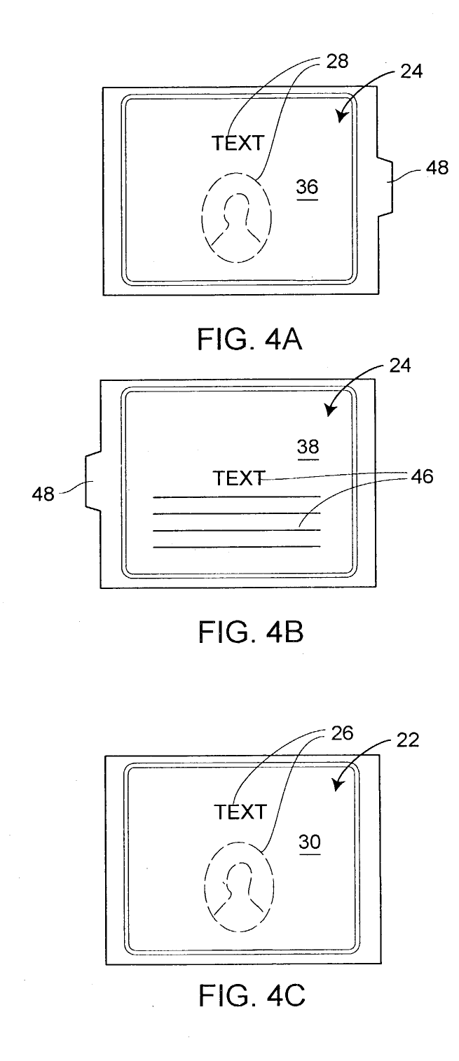

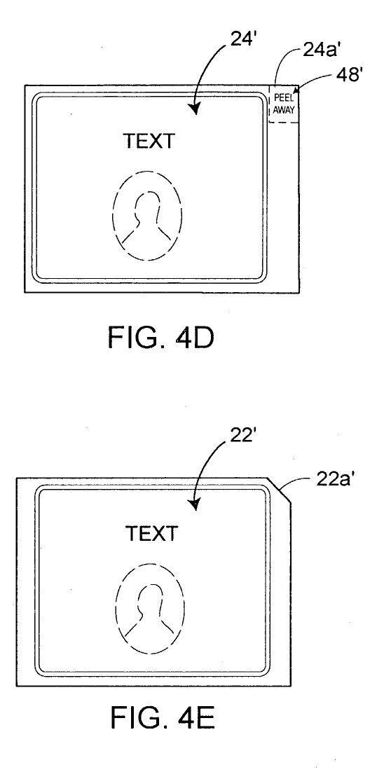

As shown in FIGS. 1-3, the wine bottle 10 has a composite label 20 attached to the body 18 which is defined by a base label 22 and a top label 24. FIGS. 4a-4c illustrate the base label 22 and top label 24 each having printed thereon which is generally designated 26 and 28, respectively, and FIGS. 4d and 4e illustrate an alternative form of base label 22′ and top label 24′ in which the base label 22′ has a cutoff portion 22a′ such as a corner discussed further hereinafter. In FIGS. 4a-4c, the indicia 26 includes at least legally required product information whereas the indicia 28 include at least wine recollection facilitating information.

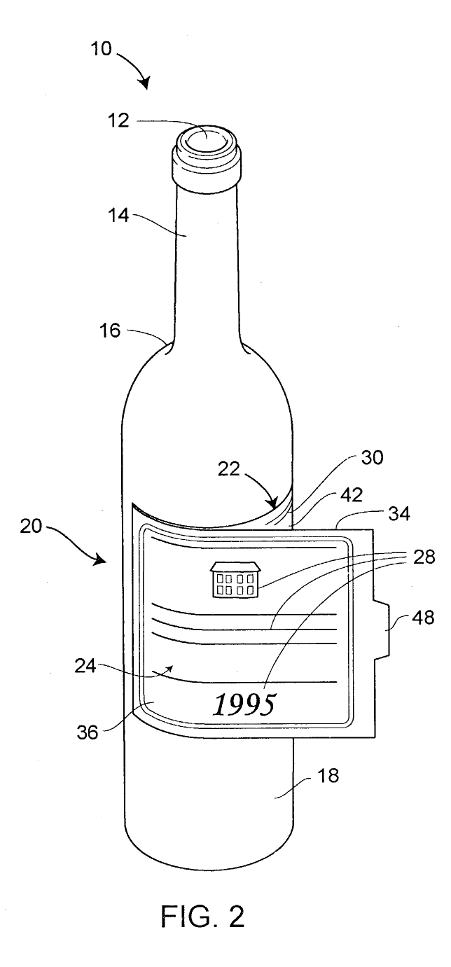

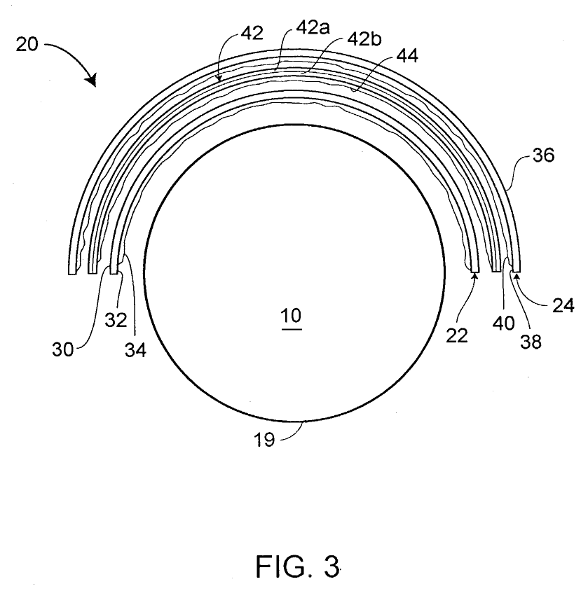

Referring to FIGS. 2 and 3, the top label 24 is releaseably secured to the base label 22 to form the composite label 20 in a manner permitting the top label 24 to be separated from the base label 22. In addition, the base label 22 is permanently secured to the bottle 10 in the sense that the base label 22 remains on the bottle 10 upon separation of the top label 24 from the base label 22.

More specifically, the base label 22 includes an outer surface 30 (FIG. 4c) for printing at least indicia 26 thereon and also includes an inner surface 32 directly opposite the outer surface 30 adapted to be permanently secured to the bottle 10. The base label 22 is permanently secured to the bottle 10 by directly applying an adhesive as at 34 to the inner surface 32 of the base label 22 after the composite label 20 has been formed, following which the composite label 20 is affixed to the bottle 10 (FIG. 3). Further, the top label 24 includes an outer surface 36 (FIG. 4a) for printing at least indicia 28 thereon and an inner surface 38 (FIG. 4b) opposite the outer surface 36 adapted to be releaseably secured to the base label 22.

As will be appreciated from FIG. 3, the top label 24 is releasably secured to the base label 22 in a manner facilitating removal of the top label 24 and, as a first step, a release adhesive as at 40 is applied to the inner surface 38 of the top label 24. Next, a laminate film 42 is provided which is comprised of two layers 42a and 42b that are adhered to one another under high pressure by using rollers or the like. The laminate film 42 is adhered to the inner surface 38 of the top label 24 by bringing the layer 42a into contact with the release adhesive as at 40 on the inner surface 38 of the top label 24. The top label 24 with the laminate film 42 adhered thereto by the release adhesive as at 40 on the inner surface 38 thereof is then adhered to the outer surface 30 of the base label 22. The laminate film 42 preferably has a release adhesive as at 44 on the outer surface of the layer 42b which is placed into contact with the outer surface 30 of the base label 22. The inner surface 38 of the top label 24 may also be provided with printed indicia as at 46 (FIG. 4b) which may comprise any printing including printing that would not ordinarily be found on a wine bottle. The printing could be informational, promotional, or of any other nature thereby providing a great deal of flexibility in communicating information to the consumer. However, the printed indicia 46 will be printed prior to adhering the laminate film 42 to the inner surface 38 of the top label 24 and will advantageously include at least wine recollection facilitating information.

In the embodiment illustrated in FIGS. 1-3, the base label 22 and top label 24 are formed to be of substantially the same size and shape. It will also be appreciated that substantially the same indicia 26 and 28 may be printed on the outer surfaces 30 and 36 of the base and top labels 22 and 24, respectively. However, the inner surface 38 of the top label 24 may, if desired, have printed indicia 46 substantially different from the indicia 26 and 28.

As shown in FIGS. 1-3, the printed indicia 26 and 28 on the outer surfaces 30 and 36 of the base label and top label 22 and 24, respectively, includes conventional wine label indicia. The printed indicia 46 on the inner surface 38 of the top label 24 may advantageously comprise any desired matter including, but not limited to, vineyard, variety and vintage information and/or other information concerning the characteristics of the wine and the like. Alternatively, or in addition, the printed indicia 46 on the inner surface 38 of the top label 24 may comprise a lined area for consumers to make wine tasting or other notes thereon.

As still one additional aspect of the present invention, the top label 24 may include a peel away area 48 which can be generally elongated in shape, as shown in FIG. 4a, or of any other desired shape. The peel away area 48 will be seen to comprise a tab in FIG. 4a which facilitates the start of peeling the top label 24 from the base label 22 although, in another preferred arrangement which will be understood from FIGS. 4d and 4e, the peel away area 48′ that facilitates peeling the top label 24′ from the base label 22′ comprises a portion 24a′ of the top label 24′ which overlies a cutaway portion as at 22a′ of the base label 22′. As will be appreciated, the respective peel away areas 48 and 48′ each facilitate removal of the corresponding top labels 24 and 24′ from the corresponding base labels 22 and 22′.

As shown in FIG. 4d, the top label portion 24′ may include indicia in the form of peeling information such as “peel here” printed on or near the overlying portion defining the peel away area 48′ of the top label and, in like fashion, the top label portion 24 may also include such printing on or near the tab defining the peel away area 48.

With regard to the adhesive, the adhesive as at 34 can be any of a variety of known adhesives that are presently used to retain labels on wine bottles. However, the laminate film 42 must have certain characteristics including the layers 42a and 42b being separable and retained by the respective release adhesives 40 and 44 in integral contact with the respective top and base labels 24 and 22 while leaving those labels intact and without any tackiness or residue on either of them. By way of example only, and not of limitation, the laminate film 42 may comprise a material such as Fasson® S246 by Fasson® Universal Coupon.

By utilizing the composite label 20, a consumer of the wine in the bottle 10 can easily remove the top label 24 and retain it for later reference purposes. This may include placing the top label 24 in a scrapbook with other memorabilia, placing it in a book of wine labels only, or otherwise retaining or using the top label 24 in any fashion such as preparing collages, or other works of art. In this manner, the top label 24 can be used to facilitate recollection of a wine consumed from a bottle and the advantages inherent in so doing.

To remove the top label from the base label, the consumer of the wine in the bottle 10 may simply grip the peel away area to pull the top label away from the base label until it is entirely separated therefrom. Since the top label is releaseably secured to the base label, the peel away area causes the two portions of the composite label to easily separate while leaving the base label permanently secured to the bottle 10 as required by law and leaving the top label in excellent condition to be retained by the consumer. Once the top label has been removed, it may be retained to recollect a wine that has been consumed and enjoyed or to recollect special moments in a person's life such as a wedding, a child's birth, or the like.

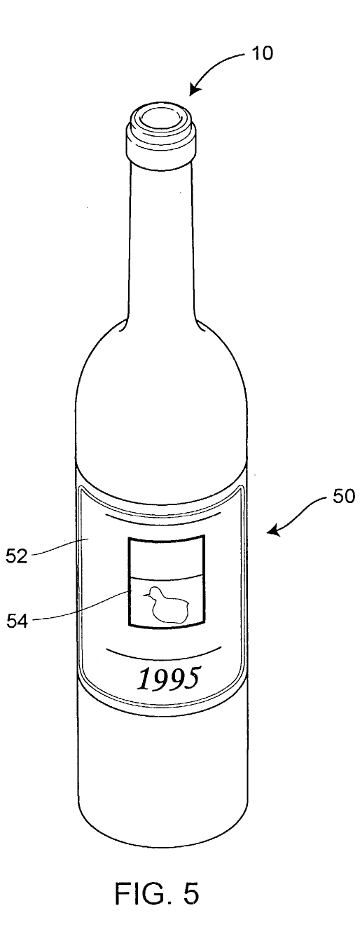

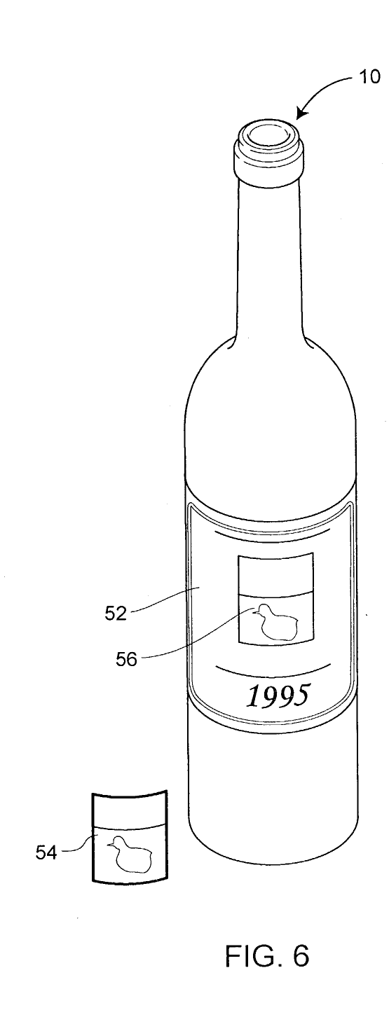

Referring now to FIGS. 5 and 6, another composite label 50 has been illustrated in the form in which it is attached to a wine bottle 10. The composite label 50 comprises a base label 52 which is permanently secured to the wine bottle 10 and a top label 54 which is releaseably secured to the base label 52 in substantially the manner which has been described above but covering only a portion 56 of the base label 52. As will be appreciated, the top label 54 is smaller than the base label 52 in the composite label 50 illustrated in FIGS. 5 and 6.

More specifically, the top label 54 comprises only a significant illustrative portion of the base label 52 to facilitate recollection of the wine consumed from the bottle 10 wherein the indicia printed on the top label 54 and the portion 56 of the base label 52 covered by the top label 54 prior to its removal are substantially identical.

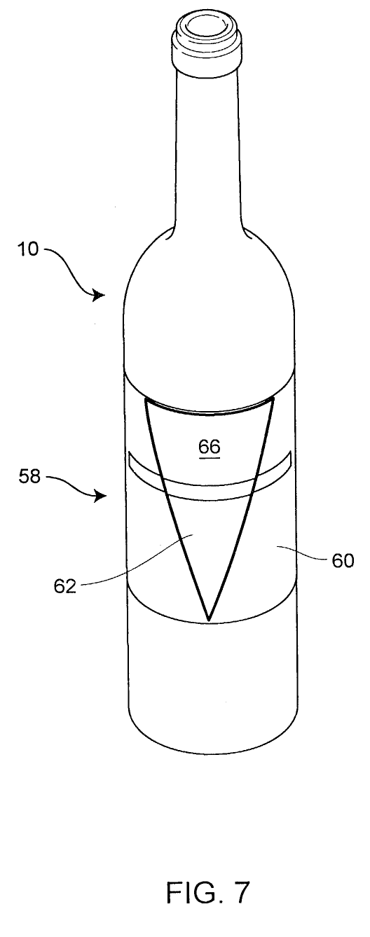

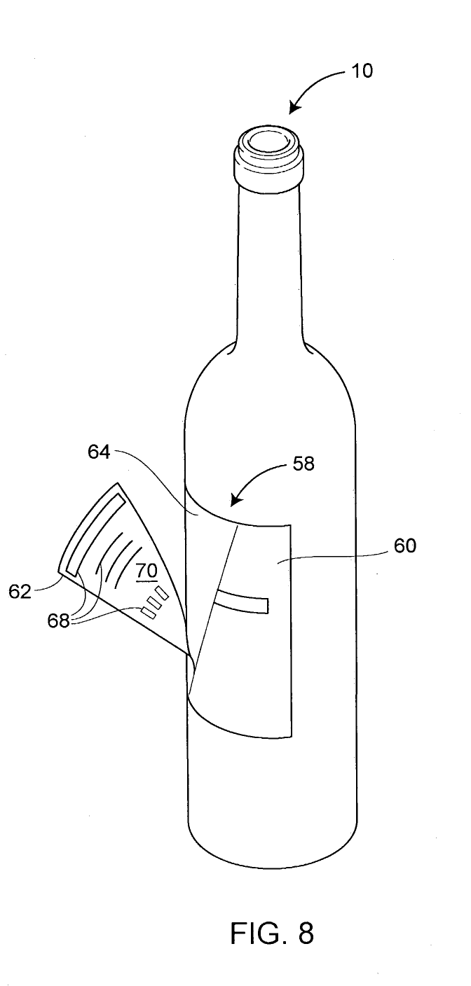

Referring now to FIGS. 7 and 8, another composite label 58 is illustrated to show another aspect of the invention. The composite label 58 is again attached to a wine bottle 10 and includes a base label 60 and a top label 62 which is triangular in shape and overlies a triangular portion 64 of the base label 60. As shown, after the top label 62 has been removed, there is no indicia printed in the triangular portion 64 of the base label 60.

While shown in this fashion, it will be appreciated that the triangular portion 64 of the base label 60 could have substantially identical indicia to that printed on the outer surface 66 of the top label 62 if desired. Further, and as shown in FIG. 8, the top label 62 may suitably included printed indicia as at 68 on the inner surface 70 of the top label 62 in the manner described above in connection with FIGS. 1-3 and 4a-4c.

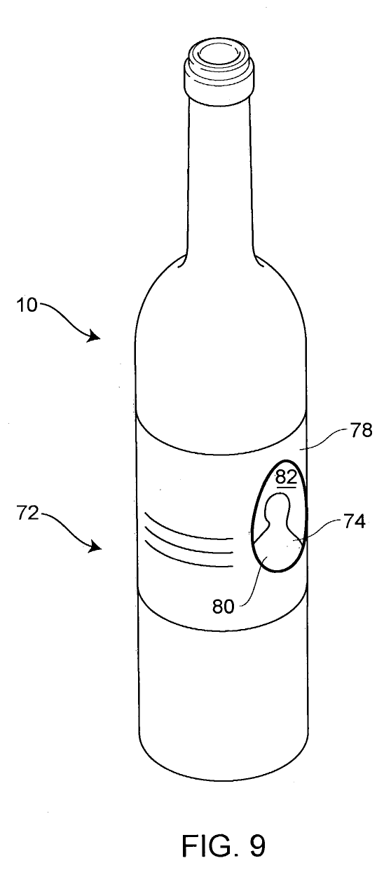

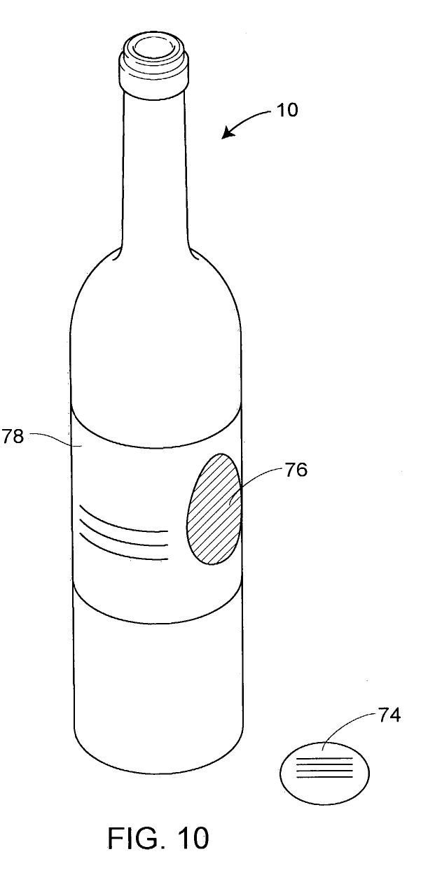

Referring now to FIGS. 9 and 10, still another composite label 72 is illustrated which, in this example, includes a top label 74 that is generally of oval shape. As with the composite label 58 illustrated in FIGS. 7 and 8, the oval portion 76 of the base label 78 has no printed indicia thereon corresponding to the printed indicia 80 on the outer surface 82 of the top label 74. From this and prior embodiments, it will be apparent that the top label and bottom label can be of any size and/or shape in relation to one another and may be provided with any relevant indicia including but not limited to information relating to vineyard, variety, vintage and the like. Moreover, all of these embodiments of composite labels accommodate all legally required product information in addition to wine recollection facilitating information.

With regard to the foregoing embodiments, an entirely unique method of facilitating recollection of a wine consumed from a bottle has been provided. The method comprises the steps of providing a base label for the bottle, and printing indicia on the base label including at least legally required product information. The method further includes the steps of providing a top label for the bottle and printing indicia on the top label including at least wine recollection facilitating information. The method further includes the step of releaseably securing the top label to the base label to form a composite label in a manner permitting the top label to be separated from the base label. Still additionally, the method includes the step of permanently securing the base label to the bottle in the sense that the base label remains on the bottle upon separation of the top label from the base label.

In addition, it will now be appreciated how the present invention accomplishes the objectives of satisfying the problems that have been encountered with regard to those who wish to recall a wine that has been consumed or an event or location where a wine has been consumed by retaining the label or a portion of the label for that purpose.

While in the foregoing there have been set forth preferred embodiments that facilitate the practice of the invention, it will be appreciated that the details herein given may be varied by those skilled in the art without departing from the spirit and scope of the appended claims.

What is claimed is:

1. A method of facilitating recollection of a wine consumed from a bottle, comprising the steps of:
providing a base label for the bottle;
printing indicia on the base label including at least legally required product information;
providing a top label for the bottle;
printing indicia on the top label including at least wine recollection facilitating information;
releasably securing the top label to the base label to form a composite label in a manner permitting the top label to be separated from the base label; and
permanently securing the base label to the bottle so as to cause the base label to remain on the bottle upon separation of the top label from the base label.

2. The method of claim 1 wherein the base label includes an outer surface for printing indicia thereon and also includes an inner surface directly opposite the outer surface adapted to be permanently secured to the bottle.

3. The method of claim 2 wherein the step of permanently securing the base label to the bottle includes the step of applying an adhesive to the inner surface of the base label after the composite label has been formed.

4. The method of claim 3 wherein the step of permanently securing the base label to the bottle includes the step of affixing the composite label to the bottle after applying the adhesive to the inner surface of the base label.

5. The method of claim 1 wherein the top label includes an outer surface for printing indicia thereon and also includes an inner surface directly opposite the outer surface adapted to be releasably secured to the base label.

6. The method of claim 5 wherein the step of releasably securing the top label to the base label includes the step of securing a separable two layer laminate film to the outer surface of the base label and the inner surface of the top label.

7. The method of claim 6 wherein the step of releasably securing the top label to the base label includes the step of affixing the top label to the base label after securing the two layer laminate film to the inner surface of the top label.

8. The method of claim 7 including the step of printing indicia on the inner surface of the top label before affixing the top label to the base label and before securing the two layer laminate film to the inner surface of the top label.

9. The method of claim 8 wherein the step of printing indicia on the inner surface of the top label includes printing at least wine recollection facilitating information prior to securing the two layer laminate film to the inner surface of the top label.

10. The method of claim 1 wherein the top label and the base label are formed to be of substantially the same size and shape.

11. The method of claim 10 in which substantially the same indicia is printed on the outer surfaces of the top and base labels.

12. The method of claim 10 including the step of printing substantially different indicia on the inner surface of the top label.

13. The method of claim 1 wherein the top label and the base label are formed to be different in at least one of size and shape.

14. The method of claim 1 wherein the top label includes a peel away area to facilitate peeling the top label from the bottom label.

15. The method of claim 14 wherein the peel away area comprises a tab formed on the top label.

16. The method of claim 14 wherein the peel away area of the top label overlies a cutaway portion of the base label.

17. The method of claim 14 peeling information indicia printed in or near the peel away area of the top label.

18. A method of facilitating recollection of a wine consumed from a bottle, comprising the steps of:
providing a base label for the bottle having an outer surface for printing indicia thereon and also having an inner surface directly opposite the outer surface adapted to be permanently secured to the bottle;
printing indicia on the outer surface of the base label including at least legally required product information;
providing a top label for the bottle having an outer surface for printing indicia thereon and also having an inner surface directly opposite the outer surface adapted to be releasably secured to the base label;
printing indicia on the outer surface of the top label including at least wine recollection facilitating information;
releasably securing the top label to the base label to form a composite label in a manner permitting the top label to be separated from the base label; and
permanently securing the base label to the bottle so as to cause the base label to remain on the bottle upon separation of the top label from the base label.

19. The method of claim 18 wherein the step of permanently securing the base label to the bottle includes the step of applying a permanent adhesive to the inner surface of the base label after the composite label has been formed.

20. The method of claim 19 wherein the step of permanently securing the base label to the bottle includes the step of affixing the composite label to the bottle after applying the adhesive to the inner surface of the base label.

21. The method of claim 20 wherein the step of releasably securing the top label to the base label includes the step of securing a separable two layer laminate film to the outer surface of the base label and the inner surface of the top label.

22. The method of claim 21 wherein the step of releasably securing the top label to the base label includes the step of affixing the top label to the base label after securing the two layer laminate film to the inner surface of the top label.

23. The method of claim 18 including the step of printing substantially identical indicia on the outer surfaces of the top and base labels and printing substantially different indicia on the inner surface of the top label.

24. The method of claim 23 wherein the step of printing substantially different indicia on the inner surface of the top label is performed at a time prior to releasably securing the top label to the base label to form the composite label.

25. The method of claim 24 wherein the step of printing indicia on the inner surface of the top label includes printing at least wine recollection facilitating information prior to releasably securing the top label to the base label.

26. The method of claim 25 wherein the step of printing indicia on the outer surfaces of the top and base labels includes printing conventional wine label indicia.

27. The method of claim 25 wherein the step of printing indicia on the inner surface of the top label includes printing vineyard, variety and vintage information.

28. The method of claim 25 wherein the step of printing indicia on the inner surface of the top label includes printing information concerning wine characteristics.

29. The method of claim 25 wherein the step of printing indicia on the inner surface of the top label includes printing an area for consumers to make wine tasting notes.
